(19) United States
(12) Patent Application Publication
(10) Pub. No.: US 2015/0071733 A1
(43) Pub. Date: Mar. 12, 2015

(54) DECORATIVE ATTACHMENT DEVICE

(71) Applicant: Jeremy Christopher Stapel, New Richmond, WI (US)

(72) Inventor: Jeremy Christopher Stapel, New Richmond, WI (US)

(21) Appl. No.: 14/482,655

(22) Filed: Sep. 10, 2014

Related U.S. Application Data
(60) Provisional application No. 61/875,957, filed on Sep. 10, 2013.

(51) Int. Cl. F16B 37/00

(52) U.S. Cl. CPC F16B 37/00
USPC 411/427; 52/741.1

(57) ABSTRACT

A threaded barrel nut is provided. The threaded barrel nut may include a plate having a front surface and a rear surface. The threaded nut may further include a threaded barrel attached to the plate. The present invention may further include a decorative face attached to the plate and covering at least a portion of the rear surface. A bolt may pass through an opening of a utility component and through an opening in the fence. The bolt may secure to the threaded barrel nut on an opposite side of the fence, thereby attaching the utility component to the fence. The decorative face may cover the rear surface of the threaded barrel nut.

### CROSS-REFERENCE TO RELATED APPLICATION

This application claims the benefit of priority of U.S. provisional application number 61/875,957, filed Sep. 10, 2013, the contents of which are herein incorporated by reference.

### BACKGROUND OF THE INVENTION

The present invention relates to attachments to a fence and, more particularly, to a decorative attachment device for a fence.

Currently, when attaching plant hangers to a fence, a bolt is passed through the plant hanger and the fence and a nut is secured to the bolt. The plant hanger is disposed on the front surface of the fence. However, a bolt and a nut are disposed on the rear surface of the fence. The bolt and the nut may be visually displeasing.

As can be seen, there is a need for a device that covers the bolt and the nut.

### SUMMARY OF THE INVENTION

In one aspect of the present invention, a threaded barrel nut comprises: a plate comprising a front surface and a rear surface; a threaded barrel attached to the plate; and a decorative face attached to the plate and covering at least a portion of the rear surface.

In another aspect of the present invention, a method of attaching a utility component to a surface comprises: drilling a hole through a wall; providing an attachment device comprising a front surface and a rear surface, a threaded barrel comprising an opening disposed towards the front surface and a decorative face covering at least a portion of the rear face; inserting a bolt through an opening of the utility component and through the hole of the wall; and screwing a threaded end of the bolt to the threaded barrel of the plate.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a back perspective view of an embodiment of the present invention;

FIG. 3 is an exploded view of FIG. 2;

FIG. 4 is a detailed perspective view of the threaded barrel plate;

FIG. 5 is a detailed exploded view of an embodiment of the present invention;

FIG. 6 is a section view taken along line 6-6 in FIG. 2; and

FIG. 7 is a detail view of FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a decorative attachment device securing an attachment device to fences and wood surfaces. The decorative attachment device may be made of steel or stainless steel. The present invention allows for an utility component, such as a plant hanger, to be attached to one side of a wall while the other side acts as a decoration. The present invention allows for improved aesthetics as well as spreading the load of what is attached to the wall and thereby increasing the weight capacity of the attachment.

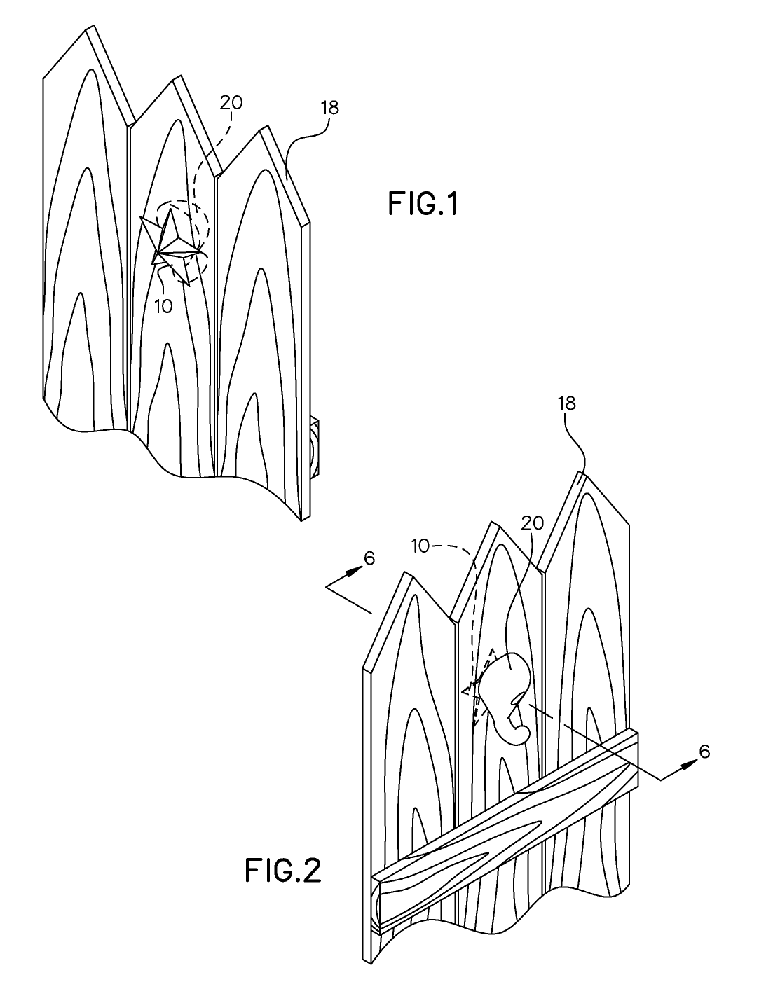

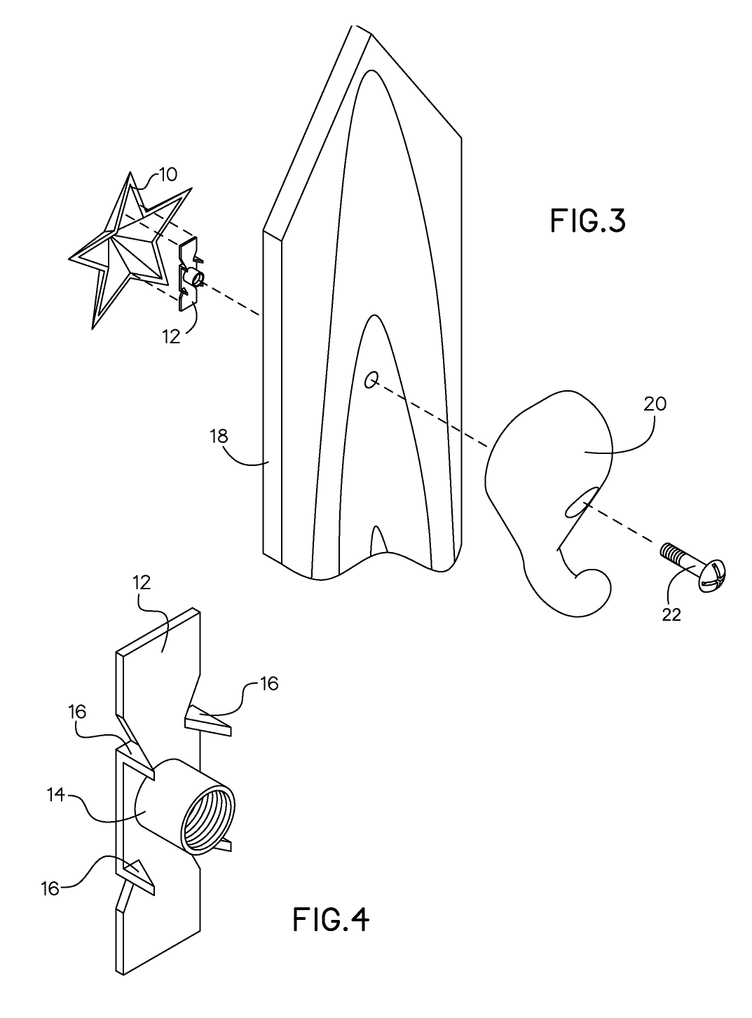

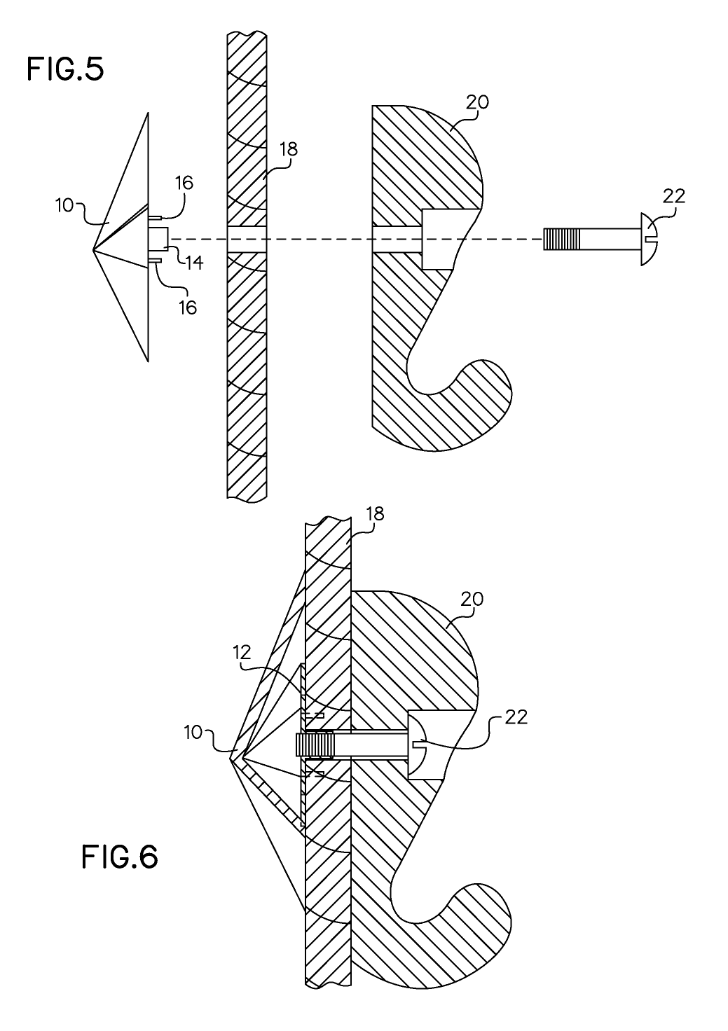

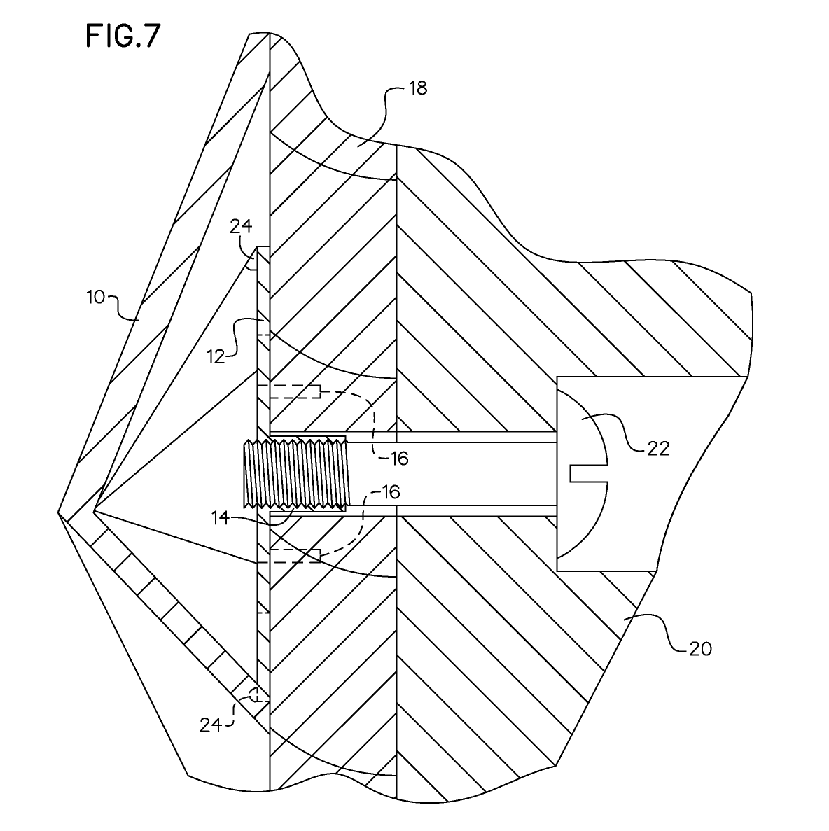

Referring to FIG. 1 through 7, the present invention includes a threaded barrel nut 12. The threaded barrel nut 12 may include a plate having a front surface and a rear surface. The threaded nut 12 may further include a threaded barrel 14 attached to the plate. The present invention may further include a decorative face 10 attached to the plate and covering at least a portion of the rear surface. As illustrated in FIG. 3, a bolt 22 may pass through an opening of a utility component 20 and through an opening in a fence 18. The bolt 22 may secure to the threaded barrel nut 12 on an opposite side of the fence 18, thereby attaching the utility component 20 to the fence 18. The decorative face 10 may cover the rear surface of the threaded barrel nut 12.

In certain embodiments, the threaded barrel 14 of the present invention may be attached to and protrude from the front surface of the plate. In such embodiments, the threaded barrel 14 may be tubular in shape and may fit through an opening through the fence 18. In certain embodiments, the threaded barrel 14 may include a first end and a second end. The first end may form an opening leading into an internal threaded portion. The second end of the threaded barrel 14 may be attached to the front surface of the plate and may from an opening through the plate. Therefore, the bolt 22 may be threaded through the first end and out the second end, as illustrated in FIG. 6.

The decorative face 10 may be any decoration, as long as the decorative face 10 at least partially covers the rear surface of the threaded barrel nut 12. For example, as illustrated in the Figures, the decorative face 10 may be a star. In certain embodiments, the decorative face 10 may be permanently affixed to the plate by weldments 24. However, the decorative face 10 may be removeably attached to the threaded barrel nut 12 by snaps, clips, adhesives and the like. In certain embodiments, the decorative face 10 may spread the load of the utility component 20. As illustrated in the Figures, the decorative face 10 may include an inner rim with a substantially larger perimeter than a regular nut. The inner rim may be pressed against the fence 18, and may thereby displace the weight of the utility component 20.

In certain embodiments, the front surface of the threaded barrel nut 12 may secure to the surface of the fence 12. As illustrated in the Figures, at least one spike 16 may protrude from the front surface. The spike 16 may be pressed or hammered into the surface of the fence 12, and may thereby prevent rotation of the decorative face 10 and the utility component 20 relative to the fence 18. In certain embodiments, the present invention may include a plurality of spikes 16, such as four spikes 16. The plurality of spikes 16 may add additional stability.

The present invention is not limited to the use of spikes 16. For example, the plate may be screwed to the fence 18 by additional screws, or may be adhered to the fence by an adhesive.

The present invention may further include a method of attaching a utility component to a wall, such as a fence. The utility components may be a hook, such as a plant hanger, solar lights, irrigation system, retractable clothesline, games, shelves, garden tool storages, and the like. A hole may be drilled through a first side and a second side of a fence. The threaded barrel of the present invention may be inserted through the hole on the first side. The spikes may be pressed or hammered into the fence. A bolt may fit through an opening of the plant hanger. The bolt may then pass through the opening of the fence on the second side so that the threaded end of the bolt is screwed into the threaded barrel. The bolt may be tightened relative to the threaded barrel so that the inner rim of the decorative face is pressed against the first side of the fence and the plant hanger is pressed against the second side of the face.

It should be understood, of course, that the foregoing relates to exemplary embodiments of the invention and that modifications may be made without departing from the spirit and scope of the invention as set forth in the following claims.

What is claimed is:

1. A threaded barrel nut comprising:
a plate comprising a front surface and a rear surface;
a threaded barrel attached to the plate; and
a decorative face attached to the plate and covering at least a portion of the rear surface.

2. The threaded barrel nut of claim 1, wherein the threaded barrel is attached to and protrudes from the front surface.

3. The threaded barrel nut of claim 1, wherein the threaded barrel comprises a first end and a second end, wherein the first end forms an opening leading into an internal threaded portion and the second end is attached to the plate and forms an opening through the plate.

4. The threaded barrel nut of claim 1, wherein the decorative face is permanently affixed to the plate.

5. The threaded barrel nut of claim 1, wherein the decorative face is removably attachable to the plate.

6. The threaded barrel nut of claim 1, further comprising at least one spike protruding from the front surface of the plate.

7. The threaded barrel nut of claim 6, wherein the at least one spike is a plurality of spikes.

8. A method of attaching a utility component to a wall comprising:
drilling a hole through the wall;
providing a threaded barrel nut comprising a front surface and a rear surface, a threaded barrel comprising an opening disposed towards the front surface and a decorative face covering at least a portion of the rear face;
inserting a bolt through an opening of the utility component and through the hole of the wall; and
screwing a threaded end of the bolt to the threaded barrel of the plate.

9. The method of claim 8, further comprising the step of pushing a plurality of spikes into the wall, wherein the plurality of spikes are attached to and protruding from the front surface.

10. The method of claim 8, further comprising the step of inserting the threaded barrel into the hole of the wall on an opposite side of the wall as the utility component.

11. The method of claim 8, further comprising the step of tightening the bolt to the threaded barrel so that an inner rim of the decorating face is pressed against the wall.

12. The method of claim 8, wherein the utility component is a plant hanger.

13. The method of claim 8, wherein the wall is a fence.
